(19) United States
(12) Patent Application Publication
(10) Pub. No.: US 2009/0321968 A1
(43) Pub. Date: Dec. 31, 2009

(54) Structure of cooling tower

(75) Inventors: Yew-Khoy Chuah, Taipei (TW); Chia-Wei Liu, Taipei (TW); Nien-Hung Yao, Taipei (TW); Min-Hsiang Hung, Taipei (TW)

Correspondence Address: SCHMEISER OLSEN & WATTS, 18 E UNIVERSITY DRIVE, SUITE # 101, MESA, AZ, 85201, US

(73) Assignee: NATIONAL TAIPEI UNIVERSITY TECHNOLOGY, Taipei (TW)

(21) Appl. No.: 12/146,198

(22) Filed: Jun. 25, 2008

(51) Int. Cl. B01F 3/04

(52) U.S. Cl. 261/109; 261/159; 261/DIG. 11

(57) ABSTRACT

An improved structure of cooling tower includes a fan housing with a fan disposed therein, induction openings distributed on the fan housing and located below the fan, and a diffuser stack disposed at one end surface of the fan housing. In operation, cold air is drawn into the cooling tower by the fan through inlet openings of the cooling tower so as to exchange heat with the condensing water within a water chiller. When warm and wet air is drawn out of the cooling tower and the warm and wet air outside the cooling tower is induced in through the induction openings and then is drawn out, circulation reflux of warm and wet air, which tends to occur in conventional cooling towers, can be avoided and therefore increase the efficiency of the water chiller.

### BACKGROUND OF THE INVENTION

1. Field of the Invention

The present invention relates to an improved structure of cooling tower and, in particular, to an improved structure of cooling tower that can avoid short circulation of warm and wet air refluxing into the cooling tower, by means of induction openings and a diffuser stack, so that the water chiller increases its efficiency.

2. Description of the Prior Art

With developments in industry and commerce, people hold a heightened standard of living. Nowadays, air conditioners have been indispensable for residential or commercial buildings. Although the application of air conditioners brings healthy and comfortable surroundings for living, it often results in the crisis of power shortage in summer. Moreover, due to the difficulty of establishing power plants and the global decrease in energy resources, a critical issue is how to save and utilize energy efficiently.

Generally, an air conditioning system operates by using a water chiller. Referring to FIG. 1, a water chiller performs heat exchange with a cooling tower 1, which can affect the efficiency of the water chiller. In high population density environments, the cooling tower 1 is usually mounted on the roof of a building. However, the available roof space is rather limited for accommodating multiple cooling towers connected in parallel. Therefore, the warm and wet air that has been drawn out of the cooling towers 1 tends to reflux circulatively. In other words, warm and wet air at the outlet of the cooling tower 1 may be circulatively drawn in through inlet opening 14 disposed at the lower portion of the cooling tower 1 and then causes short circulation. This short circulation can impose heavier loads on the cooling tower 1; thus, the dissipation capability of the cooling tower 1 can be reduced significantly, which causes the temperature of the outlet condensing water to be too high. As a result, the efficiency of the water chiller will be decreased and the power consumption will be increased.

Since the conventional way has such drawbacks as described above, it is hardly a good solution. An improvement is required urgently.

In view of the above difficulties associated with the conventional way, the present inventor, through a long-term study and practice, has developed an improvement and innovation that provides the present improved structure of fan housing for a cooling tower.

### SUMMARY OF THE INVENTION

The primary aspect of this invention is to provide an improved structure of cooling tower that can avoid the short circulation of the warm and wet air refluxing into the cooling tower, by means of induction openings and a diffuser stack, so as to increase the efficiency of the water chiller.

Another aspect of this invention is to provide an improved structure of cooling tower that can increase the heat removal efficiency of the cooling tower and the energy efficiency of the associated water chiller, so as to decrease the power consumption.

In addition, a further aspect of this invention is to provide an improved structure of cooling tower that applies a diffuser stack disposed at one end surface of a fan housing to effectively increase the flow rate of the outlet air from the fan housing as well as to facilitate the induction of air through induction openings.

An improved structure of cooling tower that can fulfill the above aspects that mainly comprises a cooling tower, a fan housing, more than one induction openings, and a diffuser stack. The fan housing contains a fan disposed therein. The induction openings are distributed on the fan housing and located below the fan, for inducing the warm and wet air outside the cooling tower into the cooling tower. The diffuser stack is disposed at one end surface of the fan housing to effectively increase the flow rate of the outlet air from the fan housing as well as to facilitate the induction of air through the induction openings. In operation, cold air is drawn into the cooling tower by the fan through inlet openings of the cooling tower so as to exchange heat with the condensing water within a water chiller, when the warm and wet air is drawn out of the cooling tower, the warm and wet air outside the cooling tower is induced in through the induction openings and then be drawn out so that circulation reflux of warm and wet air, which tends to occur in conventional cooling towers, can be avoided and therefore the efficiency of the water chiller is increased.

These features and advantages of the present invention will be fully understood and appreciated from the following detailed description of the accompanying drawings.

### BRIEF DESCRIPTION OF THE DRAWINGS

FIG. 1 is a schematic diagram of implementing a conventional cooling tower.

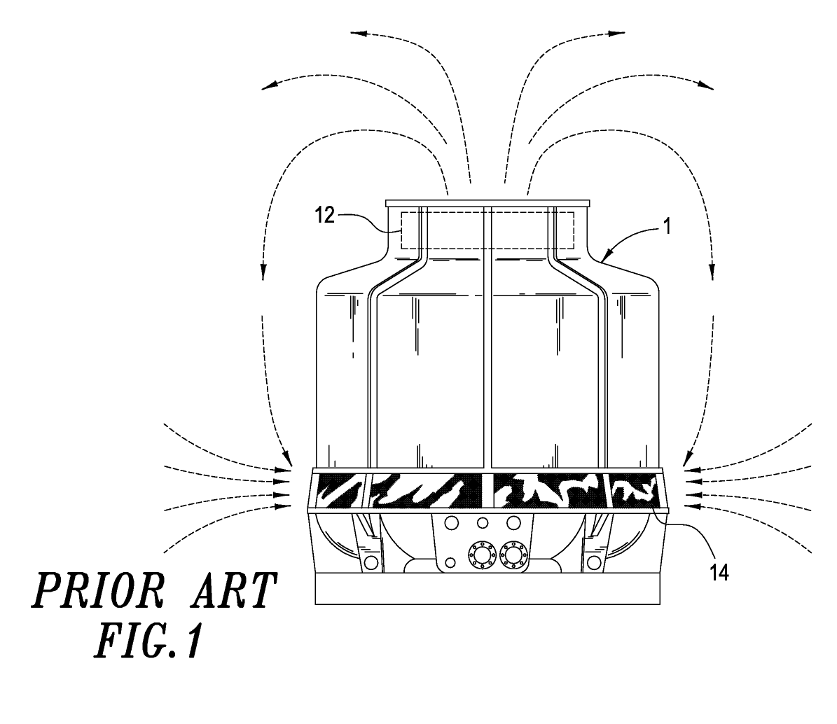

FIG. 2 is a side view of the improved structure of fan housing for cooling tower according to the present invention.

FIG. 3 is a schematic diagram of implementing the improved structure of fan housing for cooling tower according to the present invention.

### DESCRIPTION OF THE PREFERRED EMBODIMENT

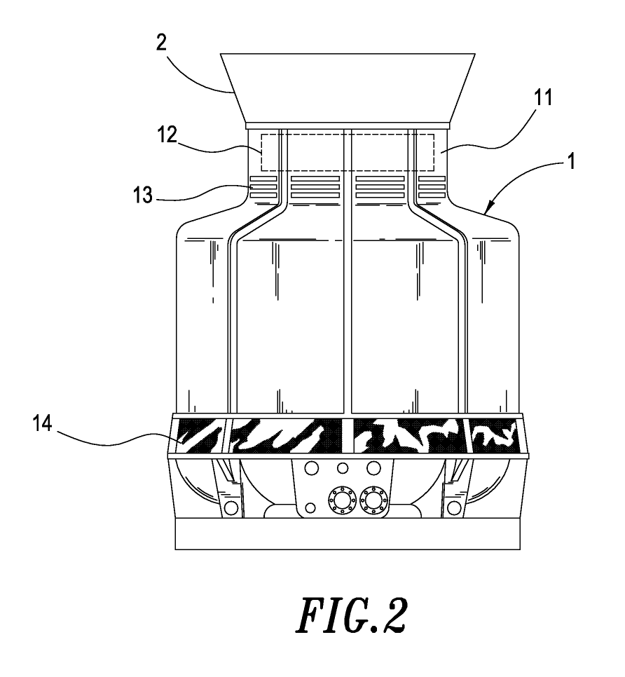

Referring to FIG. 2, which shows the improved structure of cooling tower according to the present invention, the structure of a cooling tower mainly comprises a cooling tower 1. The cooling tower 1 comprises a fan housing 11 formed at the upper portion thereof. The fan housing 11 contains a fan 12 disposed therein. The cooling tower 1 comprises more than one induction openings 13 distributed on the fan housing 11 and located below the fan 12. The cooling tower 1 also comprises more than one inlet openings 14 disposed at the lower portion thereof,

The cooling tower 1 comprises a diffuser stack 2 disposed at the end surface of the fan housing 11. The diffuser stack 2 is a chimney with a wide upper portion and a narrow lower portion.

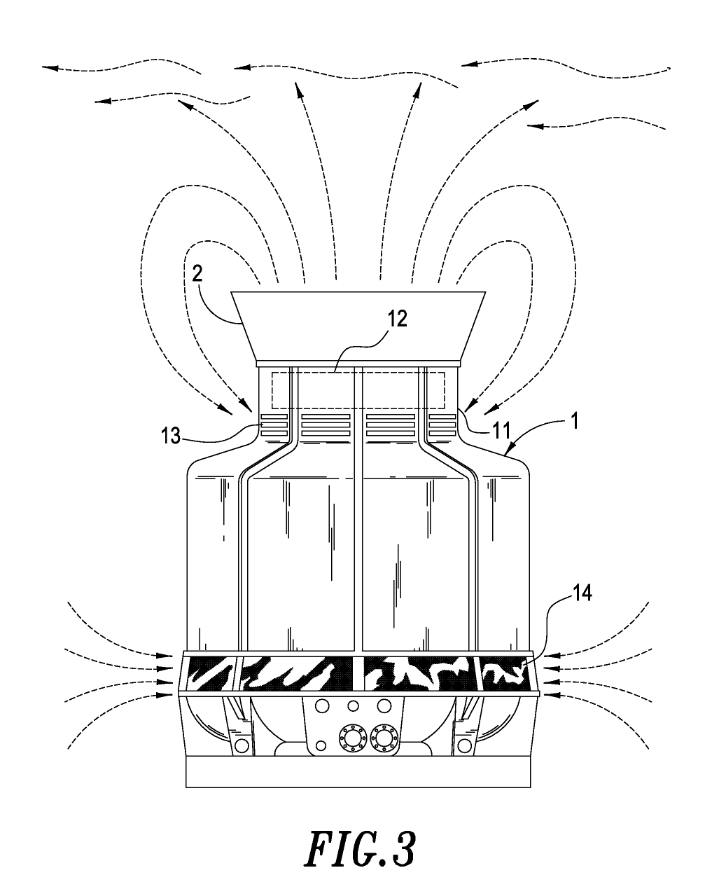

The improved structure of cooling tower according to the present invention is composed of the elements described above. By means of the induction openings and the diffuser stack in cooperation, the capability of the fan to draw air is increased effectively so that the outlet warm and wet air is rectified and, thus, expelled quickly to a higher level of the atmosphere, as shown in FIG. 3. Furthermore, as the induction openings produce a negative pressure, the air outside the cooling tower can be induced. Thus, part of the subsiding warm and wet air outside the cooling tower can be induced into the cooling tower and then be drawn out by the fan. Thus, the short circulation can be avoided and the heat removal efficiency of the cooling tower and the energy efficiency of the associated water chiller can be increased.

The improved structure of fan housing for cooling tower provided by the present invention, as compared with conventional technologies, has the following advantages.

1. It can avoid the short circulation of the warm and wet air refluxing into the cooling tower by means of induction openings and a diffuser stack in cooperation, so as to increase the efficiency of the water chiller.

2. It can increase the heat removal efficiency of the cooling tower and the energy efficiency of the associated water chiller, so as to decrease the power consumption.

3. It can effectively increase the flow rate of the outlet air from the fan housing as well as facilitate the induction for air through the induction openings by means of a diffuser stack disposed at one end surface of the fan housing.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. An improved structure of cooling tower, comprising:
a cooling tower, having a fan housing formed at the upper portion thereof, the fan housing containing a fan disposed therein, and the cooling tower having more than one induction openings distributed on the fan housing and located below the fan and having more than one inlet openings disposed at the lower portion thereof,
wherein cold air can be drawn into the cooling tower by the fan, through the more than one inlet openings, while warm and wet air can be drawn out of the cooling tower by the fan, through the fan housing to the outside atmosphere, and the warm and wet air outside the cooling tower can be induced in through the induction openings and then be drawn out.

2. An improved structure of cooling tower, comprising:
a cooling tower, having a fan housing formed at the upper portion thereof, the fan housing containing a fan disposed therein, and the cooling tower having more than one induction openings distributed on the fan housing and located below the fan, and having more than one inlet openings disposed at the lower portion thereof,
a diffuser stack which is disposed at one end surface of the fan housing;
wherein cold air can be drawn into the cooling tower by the fan, through the inlet openings, while warm and wet air can be drawn out of the cooling tower by the fan, through the diffuser stack to the outside atmosphere, and the warm and wet air outside the cooling tower can be induced in through the induction openings and then be drawn out.

3. The improved structure of cooling tower of claim 2, wherein the diffuser stack is a chimney with a wide upper portion and a narrow lower portion.
